(19) United States
(12) Patent Application Publication
(10) Pub. No.: US 2025/0016300 A1
(43) Pub. Date: Jan. 9, 2025

(54) HEAD-MOUNTED DISPLAY DEVICE, CONTROL METHOD THEREFOR, AND NON-TRANSITORY COMPUTER READABLE STORAGE MEDIUM

(71) Applicant: CANON KABUSHIKI KAISHA, Tokyo (JP)

(72) Inventor: YUKI SHIRAKAWA, Kanagawa (JP)

(21) Appl. No.: 18/762,430

(22) Filed: Jul. 2, 2024

(30) Foreign Application Priority Data
Jul. 6, 2023 (JP) 2023-111119

(51) Int. Cl. H04N 13/398; H04N 13/178; H04N 13/189; H04N 13/194; H04N 13/332; H04N 13/361

(52) U.S. Cl. CPC H04N 13/398; H04N 13/178; H04N 13/189; H04N 13/194; H04N 13/332; H04N 13/361

(57) ABSTRACT

A head-mounted display device includes one or more memories storing instructions, and one or more processors capable of executing the instructions causing the head-mounted display device to project a virtual space in a field of view of a user wearing the head-mounted display device, execute control processing to enable a see-through mode to check a real space, and display a virtual object generated based on captured data on a physical object in the real space within the virtual space projected in the field of view of the user, wherein the virtual object is shared with another member participating in the virtual space to allow the another member to view the virtual object.

### BACKGROUND

### Field of the Disclosure

The present disclosure relates to a technique using a head-mounted display.

### Description of the Related Art

Extended reality (XR), which is a generic term used to refer to techniques for generating a space for providing a simulated experience by fusing a virtual world with the real world, such as virtual reality (VR) and augmented reality (AR), has attracted attention. Various efforts to standardize the XR have been currently underway. In recent years, a virtual space or a service using such techniques is called “metaverse”, which has been used not only for an entertainment purpose, such as a game, but also in a business scene, such as a virtual office or a VR conference room.

Head-mounted displays (HMDs), which are devices to be used for a user to experience VR or AR content, include a fully immersive HMD that blocks the field of view of the user wearing the HMD from the real space, and a see-through HMD that provides a field of view by combining a real space, a virtual space, and virtual objects. Furthermore, there is also a type of HMD that has the functions of both the fully immersive HMD and the see-through HMD. This type of HMD is configured to switch on or off a see-through mode depending on a service or a scene in which the HMD is used.

The fully immersive HMD blocks the field of view of the user wearing the HMD from the real space, thereby allowing the user to be immersed in the virtual space. However, it is difficult for the user wearing the HMD to visually recognize an object present in the real space (such an object is hereinafter referred to as a physical object). Thus, it is difficult for the user to make a bodily movement in the real world, for example, a movement to pick up a nearby physical object while wearing the fully immersive HMD.

Japanese Patent Application Laid-Open No. 2021-26431 discusses a technique for capturing images of a physical object located near a user wearing an HMD with a camera included in the HMD, and projecting a video image of the physical object within a virtual space, in order to allow the user to make a bodily movement in the real world without impairing the sense of immersion in the virtual space.

However, according to the technique discussed in Japanese Patent Application Laid-Open No. 2021-26431, a video image of a physical object captured by the camera is simply projected on the virtual space displayed by the HMD that the user is wearing. With the technique discussed in Japanese Patent Application Laid-Open No. 2021-26431, it is difficult to add a virtual object corresponding to a physical object located near the user in the real world into the virtual space and to share the virtual object with another user in the virtual space so that the other user can handle the virtual object.

### SUMMARY

According to an aspect of the present disclosure, a head-mounted display device includes one or more memories storing instructions, and one or more processors capable of executing the instructions causing the head-mounted display device to project a virtual space in a field of view of a user wearing the head-mounted display device, execute control processing to enable a see-through mode to check a real space, and display a virtual object generated based on captured data on a physical object in the real space within the virtual space projected in the field of view of the user, wherein the virtual object is shared with another member participating in the virtual space to allow the another member to view the virtual object.

Further features of the present disclosure will become apparent from the following description of exemplary embodiments with reference to the attached drawings.

### BRIEF DESCRIPTION OF THE DRAWINGS

FIG. 1 is a diagram illustrating an overall configuration of a virtual space management system according to one or more aspects of the present disclosure.

FIG. 2 is a block diagram illustrating an example of a hardware configuration of devices constituting the virtual space management system according to one or more aspects of the present disclosure.

FIG. 3 is a block diagram illustrating an example of a software configuration of the virtual space management system according to one or more aspects of the present disclosure.

FIG. 4A illustrates a display example of a head-mounted display (HMD) according to one or more aspects of the present disclosure.

FIG. 4B illustrates a display example of the HMD according to one or more aspects of the present disclosure.

FIG. 4C illustrates a display example of the HMD according to one or more aspects of the present disclosure.

FIG. 4D illustrates a display example of the HMD according to one or more aspects of the present disclosure.

FIG. 4E illustrates a display example of the HMD according to one or more aspects of the present disclosure.

FIG. 4F illustrates a display example of the HMD according to one or more aspects of the present disclosure.

FIGS. 5A and 5B are diagrams each illustrating a camera operation method according to one or more aspects of the present disclosure.

FIG. 6 is a sequence diagram illustrating an example of an overall processing sequence according to one or more aspects of the present disclosure.

FIG. 7A illustrates a display example of the HMD according to one or more aspects of the present disclosure.

FIG. 7B illustrates a display example of the HMD according to one or more aspects of the present disclosure.

FIG. 7C illustrates a display example of the HMD according to one or more aspects of the present disclosure.

FIG. 7D illustrates a display example of the HMD according to one or more aspects of the present disclosure.

FIG. 7E illustrates a display example of the HMD according to one or more aspects of the present disclosure.

FIG. 8 is a sequence diagram illustrating an example of an overall processing sequence according to one or more aspects of the present disclosure.

### DESCRIPTION OF THE EMBODIMENTS

Exemplary embodiments of the present disclosure will be described below with reference to the drawings.

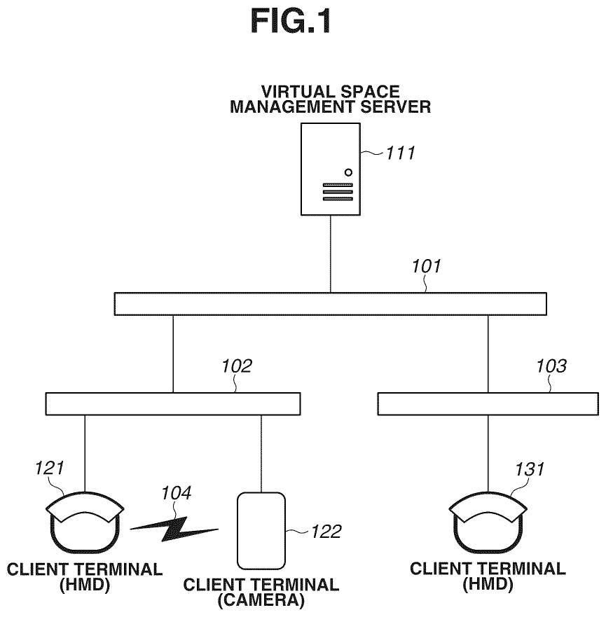

FIG. 1 illustrates an example of an overall configuration of a virtual space management system according to a first exemplary embodiment of the present disclosure.

As illustrated in FIG. 1, in the virtual space management system according to the present exemplary embodiment, a virtual space management server 111, a client terminal 121, a client terminal 122, and a client terminal 131 are connected via networks 101 to 103.

The networks 101 to 103 are so-called communication networks implemented as, for example, the Internet, a local area network (LAN), a wide area network (WAN), a phone line, a dedicated digital line, an asynchronous transfer mode (ATM), a frame relay line, a cable television line, or a data broadcasting radio line. The networks 101 to 103 may be configured to transmit and receive data. In the present exemplary embodiment, the network 101 is the Internet and the networks 102 and 103 are, for example, wired or wireless LANs connected to the Internet, a standard home network, or a corporate network. A wireless communication 104 is a communication method to be implemented based on near-field wireless communication standards such as Bluetooth® or near-field communication (NFC), and establishes a data communication between the client terminals 121 and 122.

Examples of the client terminals 121 and 131 include dedicated hardware modules adapted to project a virtual object to be handled in extended reality (XR) on a head-mounted display (HMD) or smart glasses, and mobile terminals, such as smartphones, in which a program execution environment is incorporated.

The client terminals 121 and 131 each include a camera for capturing an image of a surrounding area, and a display for projecting a virtual object. The client terminals 121 and 131 are each configured to recognize user's fingers through the camera and superimpose an operation in a real space and an operation in a virtual space, thereby providing a simulated experience in which a virtual world is fused with the real world. The client terminals 121 and 131 each include a function for displaying not only the virtual space, but also the entire or a part of the real space on the display through the camera (this function is hereinafter referred to as a “see-through mode”).

If the client terminals 121 and 131 are information processing devices other than dedicated hardware modules, such as HMDs, the client terminals 121 and 131 are each configured to project the virtual object using an application programming interface (API) provided by a web browser, an operating system (OS), or the like. The present exemplary embodiment is described assuming that the client terminals 121 and 131 are HMDs.

The client terminal 122 is an information processing device including an image capturing function (camera), such as a smartphone or a tablet, and is a hardware module for integrating a physical object into the virtual space. The client terminal 122 may be a dedicated image capturing device, such as a single-lens reflex camera or a three-dimensional (3D) scanner, which is configured to generate 3D data. The present exemplary embodiment is described assuming that a mobile terminal such as a smartphone is used.

The virtual space management server 111 is a system for providing the client terminals 121 and 131 with a virtual object in the virtual space, or a virtual object representing each user (hereinafter referred to as an “avatar”), and positional information about the virtual object. The virtual space management server 111 has a function of managing information about virtual objects transmitted from the client terminals 121 and 131 and the like, sharing states, and the like. The virtual space management server 111 also manages the users that use the client terminals 121 and 131. Specifically, the virtual space management server 111 receives a login or logout request from the client terminals 121 and 131, and performs login or logout processing.

The virtual space management server 111 is constructed using a server computer. Alternatively, the virtual space management server 111 may be constructed using a cloud computing technique or the like. The functions of the virtual space management server 111 described in the present exemplary embodiment may be implemented by a single server or a single virtual server, or may be implemented by a plurality of servers or a plurality of virtual servers. Yet alternatively, a plurality of virtual servers may be executed on a single server.

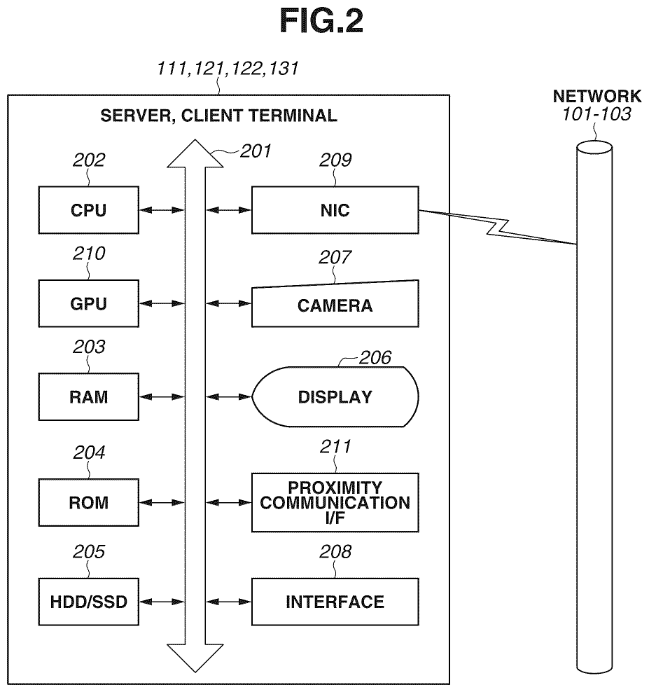

FIG. 2 is a block diagram illustrating an example of a hardware configuration of the virtual space management server 111 and the client terminals 121, 122, and 131.

In the configuration example of FIG. 2, a central processing unit (CPU) 202 controls the overall operation of each device. The CPU 202 executes various programs, such as application programs and an operating system (OS) stored in a hard disk drive (HDD)/solid-state drive (SSD) 205. In this case, the CPU 202 performs control processing to temporarily store information, files, and the like to be used for executing programs in a random access memory (RAM) 203.

A graphics processing unit (GPU) 210 performs arithmetic processing for projecting a virtual object or an avatar in real time.

The RAM 203 is a temporary storage unit, and functions as a main memory, a working area, or the like for the CPU 202 and the GPU 210.

A read-only memory (ROM) 204 is a storage unit that stores various data such as basic input/output (I/O) programs.

The HDD/SSD 205 is an example of an external storage unit. The HDD/SSD 205 functions as a large-capacity memory, and stores programs for applications, such as a web browser, programs for a service server group, an OS, related programs, and the like.

A display 206 is a display unit that displays a virtual object, information to be used for an operation, and the like. The display 206 may be a device which has a function of receiving an operation instruction from the user, such as a touch panel.

A camera 207 is, for example, an out-camera for capturing a video image of a surrounding area, or an in-camera for mainly capturing an image of the user in the client terminals 121, 122, and 131. Performing analysis of a video image captured by the camera 207, the out-camera in particular, using an application program stored in the HDD/SSD 205 makes it possible to synchronize the motions of user's fingers in the real space with the motions of avatar's fingers in the virtual space. Pictures and video images (a plurality of images captured from a plurality of angles as described below) captured by the camera 207 of the client terminal 122 are combined and processed by application programs stored in the HDD/SSD 205. This makes it possible to generate a virtual object that can be handled by the client terminals 121 and 131 and the virtual space management server 111. The virtual space management server 111 need not necessarily include the camera 207.

An interface 208 is an external device interface (I/F) that connects peripheral devices such as various external sensors. The user's fingers in the real space are recognized by the camera 207 described above, thereby enabling the user to perform an operation on the virtual object or contact another avatar in the virtual space. The equivalent function can be implemented by operating a dedicated controller connected to the interface 208.

A system bus 201 manages a data flow in the device.

A network interface card (NIC) 209 exchanges data with an external device via the networks 101 and 103.

A proximity communication I/F 211 is a network I/F for proximity communication such as NFC or Bluetooth®. The use of the proximity communication I/F 211 enables transmission and reception of data among the client terminals 121, 122, and 131.

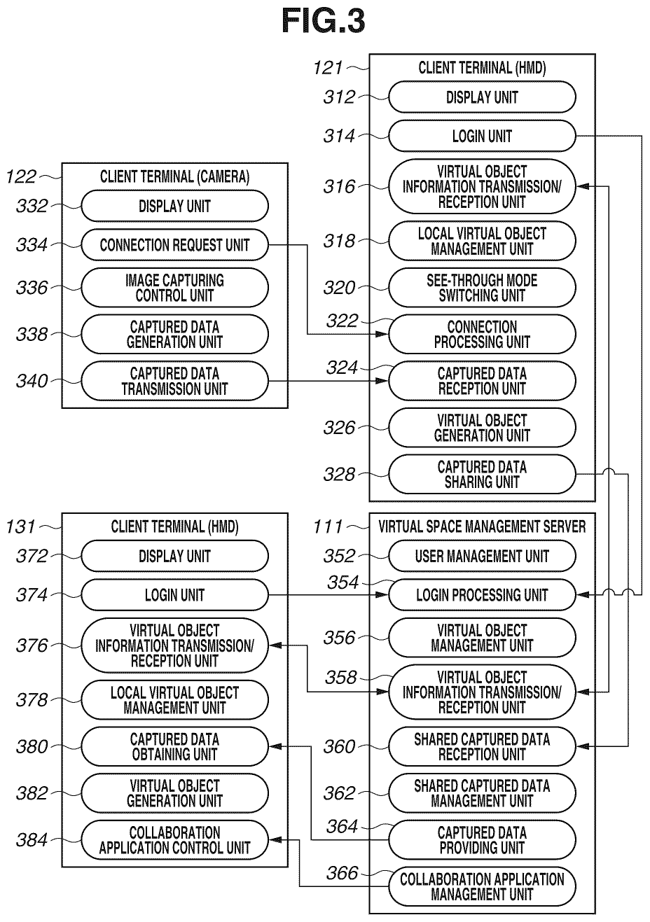

The above-described computer configuration is merely an example, and the configuration according to the present exemplary embodiment is not limited to the configuration example illustrated in FIG. 2. For example, data and programs can be stored in any one of the RAM 203, the ROM 204, and the HDD/SSD 205 depending on the features of the data and programs. In addition, the CPU 202 and the GPU 210 execute processing based on programs stored in the HDD/SSD 205, thereby implementing processing in a software configuration as illustrated in FIG. 3.

FIG. 3 is a block diagram illustrating an example of a software configuration of some of functions according to the present exemplary embodiment in the virtual space management server 111 and the client terminals 121, 122, and 131.

### <Client Terminal 122>

The client terminal 122 includes a display unit 332, a connection request unit 334, an image capturing control unit 336, a captured data generation unit 338, and a captured data transmission unit 340. The client terminal 122 captures an image of a physical object in the real space that a user wants to integrate as a virtual object into a virtual space, thereby generating 3D data. Each unit of the client terminal 122 illustrated in FIG. 3 is implemented by the CPU 202 of the client terminal 122 reading out programs stored in the ROM 204 or the HDD/SSD 205 and executing the programs. Each unit will be described in detail below.

The display unit 332 is a software module for displaying the real space to be displayed through the camera 207 and a user interface (UI) for selecting an image capturing mode to be described below on the display 206.

The connection request unit 334 issues a connection request to a connection processing unit 322 of the client terminal 121 via the proximity communication I/F 211 to exchange data to be described below with the client terminal 121.

The image capturing control unit 336 is a software module for instructing the camera 207 to perform camera start processing, image capturing processing, and the like, and has, for example, a function of switching the image capturing mode to be described below.

The captured data generation unit 338 is a software module for generating 3D data by combining images (a plurality of images captured from a plurality of angles as described below) of the real space captured by the camera 207. The captured data generation unit 338 generates 3D data and obtains a feature amount (physical object itself and its background, an object on a table, or a pattern, etc.) in a surrounding space including the physical object as an image capturing target from captured images. The captured data generation unit 338 associates the generated 3D data with the feature amount to generate combined data. When a virtual object generation unit 326 of the client terminal 121 generates a virtual object based on the 3D data, this makes it possible not only to project the generated virtual object on the display 206, but also to project the virtual object at an appropriate projection position.

This technique is called “spatial anchor”, which makes it possible to arrange a target virtual object at a position where the feature amount in the real space matches the feature amount included in captured data when the target virtual object is projected on different terminals. In the present exemplary embodiment, this technique is used to determine the projection position when 3D data on the physical object captured and generated by the client terminal 122 is projected on the display 206 of the client terminal 121. The 3D data generated by the captured data generation unit 338 and the feature amount associated with the 3D data are hereinafter collectively referred to as “captured data”.

The captured data transmission unit 340 transmits the captured data generated by the captured data generation unit 338 to a captured data reception unit 324 of the client terminal 121.

### <Client Terminal 121>

The client terminal 121 includes, as basic functions for implementing a virtual space, a display unit 312, a login unit 314, a virtual object information transmission/reception unit 316, a local virtual object management unit 318, a see-through mode switching unit 320, and the connection processing unit 322. The client terminal 121 also includes the captured data reception unit 324, the virtual object generation unit 326, and a captured data sharing unit 328. Each unit of the client terminal 121 illustrated in FIG. 3 is implemented by the CPU 202 of the client terminal 121 reading out programs stored in the ROM 204 or the HDD/SSD 205 and executing the programs. Each unit will be described in detail below.

The display unit 312 is a software module for performing display control processing to project an operation UI, a virtual object or an avatar in the virtual space, and a video image of the real space captured by the camera 207 of the client terminal 121 on the display 206 of the client terminal 121 serving as an HMD.

The login unit 314 transmits images of user's fingers captured by the camera 207 of the client terminal 121 and a user name and a password input by an input device connected to the interface 208 to a login processing unit 354 of the virtual space management server 111. Examples of an authentication method for the virtual space management server 111 include face authentication using a face image captured by the camera 207 of the client terminal 121, iris authentication using an iris image, and fingerprint authentication using a fingerprint sensor connected to the interface 208.

The virtual object information transmission/reception unit 316 obtains 3D data on the virtual object or avatar and positional information about the virtual object or avatar from a virtual object information transmission/reception unit 358 of the virtual space management server 111, and stores the obtained 3D data and positional information in the local virtual object management unit 318. Further, the virtual object information transmission/reception unit 316 has a function of transmitting the positional information about the virtual object or avatar that has changed when the user performs an operation on the client terminal 121 to the virtual object information transmission/reception unit 358 of the virtual space management server 111.

The local virtual object management unit 318 manages the 3D data, positional information, or the like on the virtual object or avatar obtained from the virtual object information transmission/reception unit 358 of the virtual space management server 111. Further, the local virtual object management unit 318 has a function of detecting the position of the virtual object or avatar on the client terminal 121 that has changed when an operation is performed on the client terminal 121, and of storing the positional information in the local virtual object management unit 318. The data entities managed by the local virtual object management unit 318 are stored in, for example, the RAM 203 or the HDD/SSD 205 of the client terminal 121.

The functions of the virtual object information transmission/reception unit 316 and the local virtual object management unit 318 make it possible to reflect a behavior or a state of the virtual object or avatar within the virtual space provided by the virtual space management server 111 on the display 206 of the client terminal 121 in real time.

The see-through mode switching unit 320 is a software module for issuing, to the display unit 312, an instruction indicating whether to project the video image of the real space that can be obtained through the camera 207 of the client terminal 121 on the display 206 of the client terminal 121. In the present exemplary embodiment, it is assumed that the see-through mode is switched based on a user operation. However, the condition for switching the see-through mode is not particularly limited. The see-through mode may be switched, for example, when the user turns on or off a hardware switch included in the client terminal 121, or when a gesture, an audio assist, or a physical object is automatically detected.

The connection processing unit 322 processes the connection request from the connection request unit 334 of the client terminal 122. After the connection is allowed, the connection processing unit 322 exchanges data with the client terminal 122.

The captured data reception unit 324 receives the captured data transmitted from the captured data transmission unit 340 of the client terminal 122.

The virtual object generation unit 326 generates a virtual object that can be projected within the virtual space projected on the client terminal 121, based on the captured data received by the captured data reception unit 324, and determines a position where the virtual object is to be projected. The virtual object generation unit 326 uses the above-described spatial anchor technique to detect a position where the feature amount included in the captured data obtained through the camera 207 of the client terminal 121 is similar to the feature amount in the real space. In this case, the see-through mode in the HMD of the client terminal 121 is ON (enabled) and the video image of the real space can be seen through the camera 207 of the client terminal 121. If the position where the feature amount included in the captured data is similar to the feature amount in the real space is detected, the virtual object generation unit 326 instructs the display unit 312 to project the virtual object generated based on the 3D data included in the captured data at the detected position.

The above-described processing enables the virtual object generation unit 326 not only to simply integrate a physical object as an image capturing target into the virtual space as a virtual object, but also to determine the projection position and integrate the physical object at the projection position. More specifically, as seen from the user wearing the HMD, the virtual object can be projected in a superimposed manner on the physical object, which provides the user with a simulated experience as if the captured physical object is floating up as the virtual object. The series of specific sequences, display examples on the display 206 of the client terminal 121, and the like will be described below.

The captured data sharing unit 328 is a software module for sharing the captured data received by the captured data reception unit 324 with another user (member) participating in the virtual space, and the captured data sharing unit 328 transmits the captured data and a sharing setting to a shared captured data reception unit 360 of the virtual space management server 111. The captured data and the sharing setting are hereinafter collectively referred to as “shared captured data”.

As another example of the software configuration of the client terminals 121 and 122 described above, the client terminal 122 may be embedded in the client terminal 121. In other words, if the client terminal 121 also has the functions of the client terminal 122, the above-described functions may be implemented by only the hardware of the client terminal 121.

### <Virtual Space Management Server 111>

The virtual space management server 111 includes, as basic functions for providing a virtual space, a user management unit 352, the login processing unit 354, a virtual object management unit 356, and the virtual object information transmission/reception unit 358. The virtual space management server 111 also includes the shared captured data reception unit 360, a shared captured data management unit 362, a captured data providing unit 364, and a collaboration application management unit 366 to be described in a second exemplary embodiment. Each unit of the virtual space management server 111 illustrated in FIG. 3 is implemented by the CPU 202 of the virtual space management server 111 reading out programs stored in the ROM 204 or the HDD/SSD 205 and executing the programs. Each unit will be described in detail below.

The user management unit 352 manages user information and login information.

The login processing unit 354 receives a login request from the client terminals 121 and 131, performs login processing by collating data managed by the user management unit 352, and returns a login processing result to the client terminals 121 and 131. Table 1 below illustrates an example of data managed by the user management unit 352.

TABLE 1
User Management Table

| User ID | Password | Login State | Login Validity Period |
|---|---|---|---|
| userA | ********** | on | 2022/12/31 0:00 |
| userB | ********** | on | 2022/12/31 0:00 |
| userC | ********** | off | |

The user management unit 352 manages data using, for example, a user management table as illustrated in Table 1. In the user management table illustrated in Table 1, a user identification (ID) row indicates an ID for uniquely identifying each user. A password row indicates a password for basic authentication, which is to be used for the user having the user ID to log in. The login processing unit 354 collates a combination of a user ID and a password included in the login request from the client terminals 121 and 131 with Table 1. If the data match, the login processing unit 354 returns a result indicating the login is successful to the client terminals 121 and 131. If the data do not match, the login processing unit 354 returns a result indicating that the login is unsuccessful to the client terminals 121 and 131.

A login state row indicates a login state of the user. In the login state row, “on” indicates a login state and “off” indicates a logout state. A login validation period row indicates an authentication state validation period of the login user.

The virtual object management unit 356 manages 3D data on the virtual object or the avatar of each user to be arranged in the virtual space, positional information about the virtual object or the avatar on the virtual space, and the like.

The virtual object information transmission/reception unit 358 has a function of providing the client terminals 121 and 131 with the virtual object or the avatar, positional information about the virtual object or the avatar, and the like managed by the virtual object management unit 356. The virtual object information transmission/reception unit 358 also has a function of receiving positional information from the client terminals 121 and 131 periodically or when the position of the virtual object or the avatar within the virtual space has changed by an operation from the client terminals 121 and 131.

Table 2 illustrates an example of positional information about the avatar of each user managed by the virtual object management unit 356.

TABLE 2
Avatar Position Information Management Table

| User | Space | Main | Left-hand | Right-hand |
|---|---|---|---|---|
| ID | ID | Coordinates | Coordinates | Coordinates |
| userA | roomA | (100, 100, 5) | (100, 98, 5) | (100, 102, 5) |
| userB | roomA | (100, 104, 5) | (100, 102, 5) | (100, 106, 5) |
| userC | — | — | — | — |

The virtual object management unit 356 manages avatar position information, for example, using an avatar position information management table as illustrated in Table 2. In the avatar position information management table of Table 2, a user ID row indicates an ID for uniquely identifying each user. A space ID row indicates an ID for uniquely identifying a virtual space. A main coordinates row indicates information indicating a current position (center of mass) of the avatar.

A left-hand coordinates row indicates information about the position of the left hand of the avatar, and a right-hand coordinates row indicates information about the position of the right hand of the avatar. The left-hand coordinates and the right-hand coordinates can also be used as information based on which a contact state with the virtual object or the avatar is determined.

Table 3 illustrates an example of positional information about each virtual object.

TABLE 3
Virtual Object Position Information Management Table

| Virtual Object ID | Space ID | Main Coordinates |
|---|---|---|
| objectA | roomA | (99, 100, 5) |
| SystemB | roomA | (1, 2, 3) |
| SystemC | roomA | (998, 999, 1000) |

The virtual object management unit 356 manages virtual object position information, for example, using a virtual object position information table as illustrated in Table 3. In the virtual object position information management table of Table 3, a virtual object ID row indicates an ID for uniquely identifying a virtual object in the virtual space. The space ID row and the main coordinates row are similar to those described above regarding Table 2.

Thus, the client terminals 121 and 131 and the virtual space management server 111 periodically exchange and manage positional information, thereby making it possible to reflect the position and the motion of the virtual object or the avatar on the virtual space in real time.

The shared captured data reception unit 360 is a software module for receiving shared captured data from the captured data sharing unit 328 of the client terminal 121.

The shared captured data management unit 362 manages the shared captured data received by the shared captured data reception unit 360.

Table 4 illustrates an example of a shared captured data management table to be managed by the shared captured data management unit 362.

TABLE 4
Shared Captured Data Management Table

| Sharing | Sharing | Sharing | Captured |
|---|---|---|---|
| ID | Source User | Destination User | Data ID |
| shareA | userA | userB | capturedDataA |
| shareB | userA | userC | capturedDataA |
| shareC | userB | userC | capturedDataB |

The shared captured data management unit 362 manages shared captured data, for example, using a shared captured data management table as illustrated in Table 4. In the shared captured data management table of Table 4, a sharing ID row indicates an ID for uniquely identifying a sharing setting. A sharing source user row indicates an ID for uniquely identifying a sharing source user as the owner of the captured data. A sharing destination user row indicates an ID for uniquely identifying a sharing destination user with whom the captured data is to be shared. A captured data ID row indicates an ID for uniquely identifying captured data received by the shared captured data reception unit 360. The shared captured data management unit 362 manages captured data entities in association with the captured data ID.

The captured data providing unit 364 compares the captured data with the sharing setting, and provides a comparison result to the client terminal 131. For example, assume that “userA” has logged in to the client terminal 121, “userB” has logged in to the client terminal 131, and “userA” is set to share captured data with the captured data ID “capturedDataA” with “userB”. In this case, the virtual object with the captured data ID “capturedDataA” is projected on the display 206 of the client terminal 131 to which “userB” has logged in. Unless otherwise specified, the present exemplary embodiment is described assuming that the client terminal 121 is a terminal on which the user (sharing source user) who shares captured data on the physical object performs an operation, and that the client terminal 131 is a terminal on which the user (sharing destination user) with whom the captured data is to be shared performs an operation.

The collaboration application management unit 366 is software for providing a service (e.g., a collaboration service including a message posting function) for communication between users, and has a function of providing a communication method such as chatting. The collaboration application management unit 366 also has a function of managing chat messages and attachment files from an external client terminal, and allowing each user to view the messages and attachment files. The collaboration application management unit 366 also has a function of returning content depending on the user that has logged in to the client terminal 131 in response to a chat content obtaining request from a collaboration application control unit 384. The collaboration application management unit 366 is used in the second exemplary embodiment.

The data entities managed by the user management unit 352, the virtual object management unit 356, the shared captured data management unit 362, and the collaboration application management unit 266 described above are stored in, for example, the RAM 203 or the HDD/SSD 205 of the virtual space management server 111.

### <Client Terminal 131>

The client terminal 131 includes, as basic functions for implementing a virtual space, a display unit 372, a login unit 374, a virtual object information transmission/reception unit 376, and a local virtual object management unit 378. The client terminal 131 also includes a captured data obtaining unit 380, a virtual object generation unit 382, and the collaboration application control unit 384 as features of the present disclosure. Each unit of the client terminal 131 illustrated in FIG. 3 is implemented by the CPU 202 of the client terminal 131 reading out programs stored in the ROM 204 or the HDD/SSD 205 and executing the programs. Each unit will be described in detail below.

The display unit 372 has functions equivalent to those of the display unit 312 of the client terminal 121. The login unit 374 has functions equivalent to those of the login unit 314 of the client terminal 121. The virtual object information transmission/reception unit 376 has functions equivalent to those of the virtual object information transmission/reception unit 316 of the client terminal 121. The local virtual object management unit 378 has functions equivalent to those of the local virtual object management unit 318 of the client terminal 121.

The captured data obtaining unit 380 has a function of obtaining captured data from the captured data providing unit 364 of the virtual space management server 111. The captured data obtaining unit 380 can obtain only the captured data for which the sharing setting is made as described above.

The virtual object generation unit 382 has functions similar to those of the virtual object generation unit 326, and also has a function of generating a virtual object that can be projected on the virtual space projected on the client terminal 131 based on the captured data obtained from the captured data obtaining unit 380. However, the client terminals 121 and 131 may be used in respective different real spaces in some cases.

In this case, it is difficult for the virtual object generation unit 382 to use the spatial anchor function, while the virtual object generation unit 326 generates a virtual object in a superimposed manner on a physical object captured using the spatial anchor function in the present exemplary embodiment described above. In this case, the virtual object is projected at an appropriate position (e.g., on a table within the virtual space) within the virtual space projected on the display 206 of the client terminal 131.

The collaboration application control unit 384 is a software module for controlling a service provided by the collaboration application management unit 366 to be used on the client terminal 131, and is, for example, a dedicated application or a web browser. The collaboration application control unit 384 is used together with the collaboration application management unit 366 in the second exemplary embodiment.

While the present exemplary embodiment described above illustrates an example where captured data is transmitted from the client terminal 122 to the client terminal 121 and is displayed on the client terminal 121, captured data may be transmitted from the client terminal 122 to the client terminal 121 via the virtual space management server 111 and may be displayed on the client terminal 121.

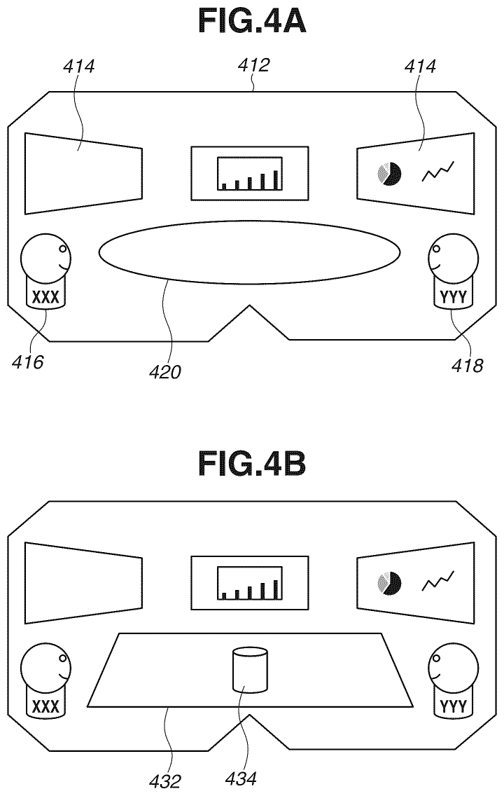

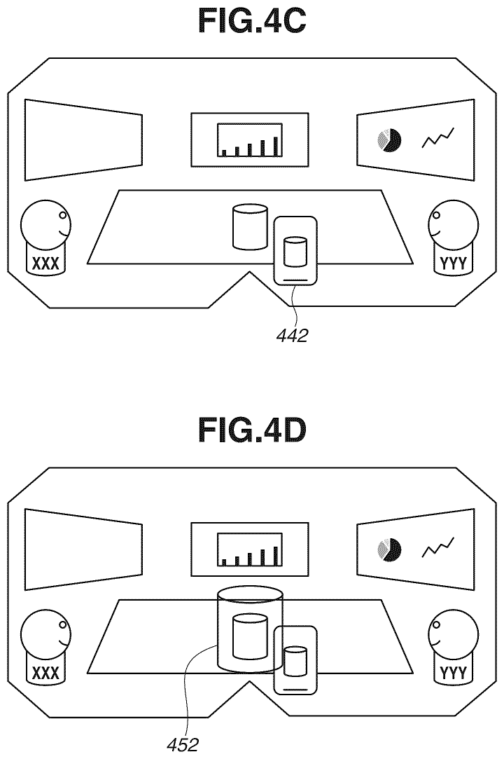

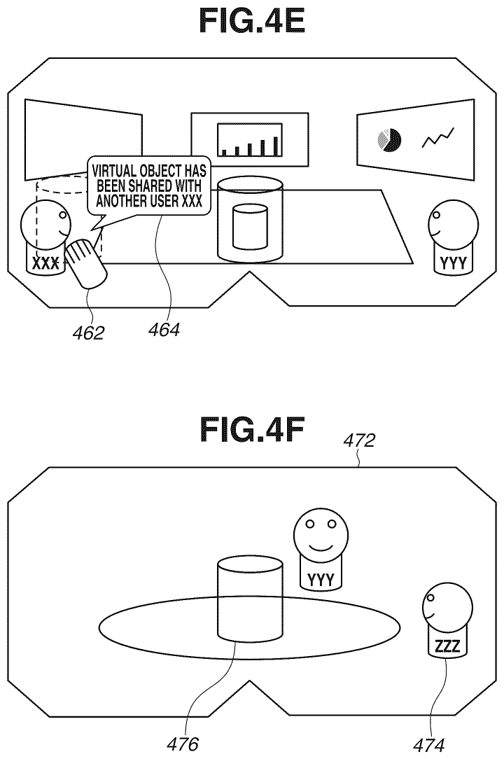

Next, a method for integrating a physical object in the real space into the virtual space as a virtual object and sharing the virtual object with another user (avatar) within the same virtual space will be described with reference to FIGS. 4A to 4F, FIGS. 5A and 5B, and FIG. 6.

FIG. 4A to 4E each illustrate an example of a video image of a virtual space projected on the display 206 of the client terminal 121.

FIG. 4F illustrates an example of a video image within the virtual space display on the display 206 of the client terminal 131.

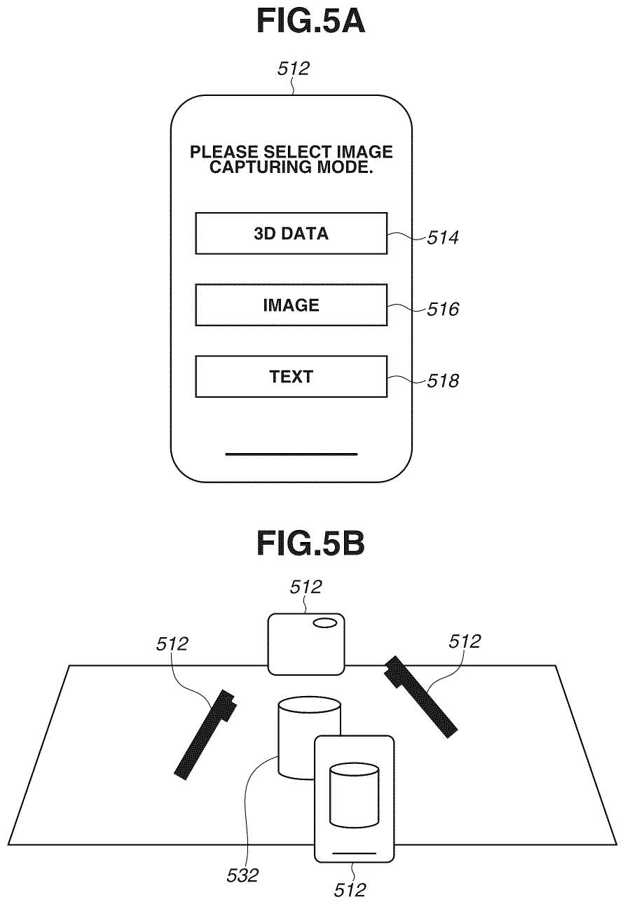

FIGS. 5A and 5B each illustrate an example of an operation method for the client terminal 122 to integrate a physical object in the real space as a virtual object into the virtual space.

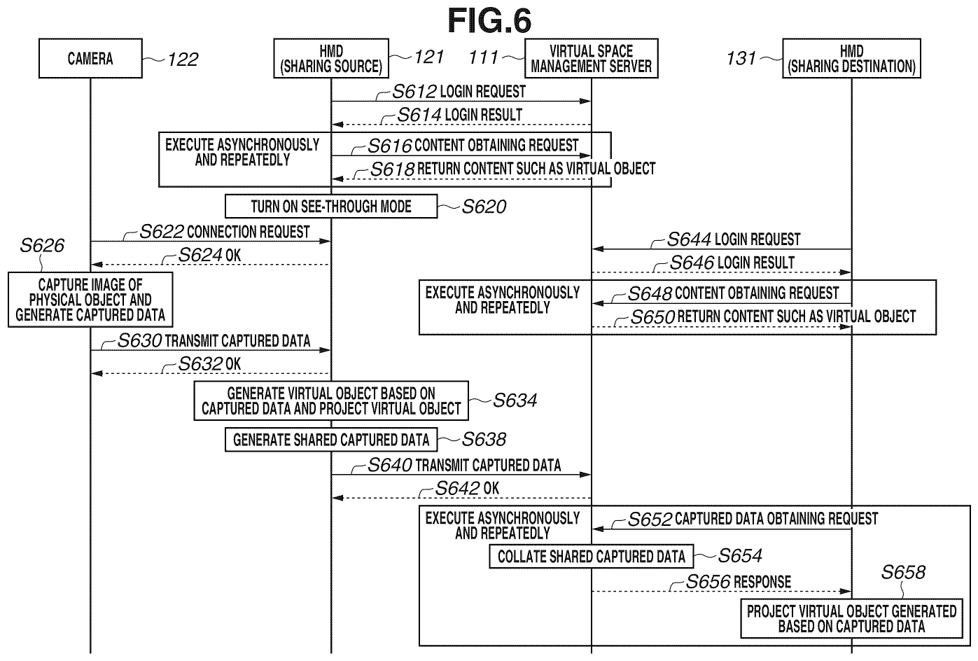

FIG. 6 is a sequence diagram illustrating an example of an overall processing sequence according to a first exemplary embodiment.

FIG. 4A illustrates a video image of a virtual space projected on the display 206 of the client terminal 121 when the see-through mode is OFF. A display 412 represents a display example on the display 206 of the client terminal 121.

Each virtual object 414 represents an operation monitor projected within the virtual space.

Avatars 416 and 418 represent other users present (participating) in the same virtual space in which the operation user of the client terminal 121 is present.

A virtual object 420 represents a table arranged within the virtual space.

FIG. 4B illustrates a video image projected on the display 206 of the client terminal 121 when the see-through mode is ON.

An object 432 represents a table arranged in the real space in which the user that operates the client terminal 121 is present.

An object 434 represents a physical object to be integrated into the virtual space. When the see-through mode is turned on, both the real space and the virtual object are projected on the display 206. Virtual objects to be projected when the see-through mode is turned on may be set in advance.

FIG. 4C illustrates a video image of the physical object 434 captured by the user operating the client terminal 121 when the see-through mode is ON. FIG. 4C and FIGS. 5A and 5B will be described below.

An object 442 represents the client terminal 122 connected to the client terminal 121. Assume herein that the operation user of the client terminal 121 is identical to the operation user of the client terminal 122.

FIG. 5A illustrates an example of a UI displayed on the display 206 of the client terminal 122. An object 512 represents the client terminal 122. Before an image of the physical object is captured in FIG. 4C, the image capturing mode is selected using the UI illustrated in FIG. 5A. In this case, the see-through mode is ON in the client terminal 121, which enables the operation user of the client terminal 121 to operate the client terminal 122 even in a state where the operation user of the client terminal 121 is wearing the HMD.

A button 514 is a button to be pressed when a physical object is to be integrated into the virtual space as 3D data, i.e., a stereoscopic virtual object. The first exemplary embodiment assumes a case where the user presses the button 514 to integrate a physical object as 3D data into the virtual space. When a button 516 is pressed, captured data on the physical object is generated as image data, and when a button 518 is pressed, captured data on the physical object is generated as text data. Operations to be performed when the buttons 516 and 518 are pressed will be described in the second exemplary embodiment.

FIG. 5B illustrates a state where an image of the physical object is captured after the user presses the button 514.

The object 512 represents the client terminal 122, which is identical to the object 442 illustrated in FIG. 4C. Similarly, an object 532 represents a physical object as an image capturing target, and is identical to the object 434 illustrated in FIG. 4B.

The captured data generation unit 338 of the client terminal 122 captures images of the physical object 532 from a plurality of angles as indicated in FIG. 5B to generate 3D data, and further obtains a feature amount of a surrounding space including the physical object 532. In the present exemplary embodiment, the method for generating 3D data is not particularly limited, and any method that can be implemented on a general smartphone can be employed. For example, the generation of 3D data can be implemented using photogrammetry, Light Detection and Ranging, Laser Imaging Detection and Ranging (LIDAR), and the like.

FIG. 4D illustrates a display example where a virtual object is generated by a user operation as described above with reference to FIG. 5B and the virtual object is projected on the display 206 of the client terminal 121 when the see-through mode is ON.

A virtual object 452 represents a virtual object obtained by capturing a physical object and integrated into the virtual space as a virtual object and projecting the virtual object on the virtual space.

By the operation described above with reference to FIG. 5B, the captured data generation unit 338 of the client terminal 122 generates captured data, and transmits the captured data to the client terminal 121 via the captured data transmission unit 340. The client terminal 121 causes the virtual object generation unit 326 to generate a virtual object based on 3D data included in the captured data received by the captured data reception unit 324. After that, the virtual object generation unit 326 detects a position where the feature amount included in the captured data is similar to the feature amount in the real space, and instructs the display unit 312 to project the virtual object on the display 206 in such a manner that the virtual object is superimposed on the captured image of the physical object. The client terminal 121 performs the processing as described above, thereby enabling the user to seamlessly integrate the physical object into the virtual space.

FIG. 4E illustrates an operation for sharing the virtual object 452 with another user in the same virtual space on the client terminal 122 when the see-through mode is ON.

A virtual object 462 represents a hand of the avatar of the user operating the client terminal 121, or a video image indicating the real hand of the user. The user operating the client terminal 121 holds the virtual object 452 with the hand, and performs a sharing operation by dropping the virtual object 452 on the avatar (in this case, avatar 416) of the user with which captured data is to be shared. A virtual object 464 is displayed when the sharing setting is made by the operation described above.

The above-described method is merely an example of the operation for sharing a virtual object with another user, and the operation method is not limited to this method. For example, a method of tapping a virtual object to be shared, displaying a UI such as a user list, and selecting a user to be set as a sharing destination user from the list may be employed. Further, the list may include not only an option for selecting a single user, but also an option for selecting a plurality of users, or an option for sharing data with all members within the virtual space. In this manner, a selection method for providing data to a plurality of users may be employed.

FIG. 4F illustrates a video image of a virtual space projected on the display 206 of the client terminal 131. In the present exemplary embodiment, there is no need for the client terminal 131 to turn on the see-through mode because the client terminal 131 does not perform image capturing processing on a physical object.

A display 472 represents a display example on the display 206 of the client terminal 131. An avatar 474 represents the user that operates the client terminal 121 as the sharing source user. When the virtual object 452 is shared by the client terminal 121, a virtual object 476 is projected on the display 206 of the client terminal 131 as a result.

Next, an overall processing sequence will be described with reference to FIG. 6. Processing to be performed by the client terminal 121 as illustrated in FIG. 6 is implemented by the CPU 202 of the client terminal 121 reading out programs stored in the ROM 204 or the HDD/SSD 205 and executing the programs. Processing to be performed by the client terminal 122 is implemented by the CPU 202 of the client terminal 122 reading out programs stored in the ROM 204 or the HDD/SSD 205 and executing the programs. Processing to be performed by the virtual space management server 111 is implemented by the CPU 202 of the virtual space management server 111 reading out programs stored in the ROM 204 or the HDD/SSD 205 and executing the programs. Processing to be performed by the client terminal 131 is implemented by the CPU 202 of the client terminal 131 reading out programs stored in the ROM 204 or the HDD/SSD 205 and executing the programs.

First, in step S612, the login unit 314 of the client terminal 121 transmits a user ID and a password to the login processing unit 354 of the virtual space management server 111 according to a login operation from the user.

Upon receiving the user ID and the password, in step S614, the login processing unit 354 of the virtual space management server 111 checks whether the received user ID and password match the user ID and password managed by the user management unit 352. If the received user ID and password match the user ID and password managed by the user management unit 352, the login processing unit 354 returns a login result indicating that the login is successful.

After the login processing unit 354 of the client terminal 121 receives information indicating that the login is successful as the login result, the processing proceeds to step S616.

In step S616, the virtual object information transmission/reception unit 316 of the client terminal 121 issues a request for obtaining content for constructing a virtual space to the virtual object information transmission/reception unit 358 of the virtual space management server 111.

After the virtual object information transmission/reception unit 358 of the virtual space management server 111 receives the request for obtaining the content for constructing the virtual space, the processing proceeds to step S618.

In step S618, the virtual object information transmission/reception unit 358 of the virtual space management server 111 returns content, such as a virtual object, in response to the content obtaining request in step S616 described above.

The virtual object information transmission/reception unit 316 that has obtained the content from the virtual space management server 111 stores the content such as the virtual object in the local virtual object management unit 318.

The above-described steps S616 and S618 are executed asynchronously and repeatedly, thereby enabling the client terminal 121 to reflect a change in the virtual space on the display 206 in real time.

In step S620, the see-through mode switching unit 320 of the client terminal 121 turns on the see-through mode according to, for example, a see-though mode switching operation performed by the user. Specifically, the see-through mode switching unit 320 instructs the display unit 312 to project the video image of the real space that can be obtained through the camera 207 of the client terminal 121 on the display 206 of the client terminal 121. Thus, control processing for viewing and checking the real space through the virtual space projected on the display 206 is implemented.

In step S622, the connection request unit 334 of the client terminal 122 issues a connection request to the connection processing unit 322 of the client terminal 121 according to a user operation on the client terminal 122.

Upon receiving the connection request, in step S624, the connection processing unit 322 of the client terminal 121 permits the connection request and returns a response to the client terminal 122.

After the connection request unit 334 of the client terminal 122 receives the response indicating that the connection is permitted, the processing proceeds to step S626.

In step S626, as illustrated in FIGS. 5A and 5B, the captured data generation unit 338 of the client terminal 122 starts to capture images of a physical object by bringing the camera 207 into an image capturing state via the image capturing control unit 336, and continuously captures images until data required for generating 3D data is obtained. If the captured data generation unit 338 determines that data required for generating 3D data is obtained, the captured data generation unit 338 stops the image capturing processing and generates captured data by combining the 3D data on the physical object with the feature amount of the surrounding space including the physical object.

Next, in step S630, the captured data transmission unit 340 of the client terminal 122 transmits the captured data generated in step S626 described above to the captured data reception unit 324 of the client terminal 121.

Upon receiving the captured data, in step S632, the captured data reception unit 324 of the client terminal 121 returns a response indicating that the captured data has been received to the client terminal 122.

Next, in step S634, the virtual object generation unit 326 of the client terminal 121 generates a virtual object that can be projected on the virtual space based on 3D data included in the captured data, determines the projection position based on the feature amount of the space, and projects the virtual object on the display 206 via the display unit 312. After completion of the processing of step S634, the state illustrated in FIG. 4D is obtained.

If the sharing operation is performed by the user, in step S638, the captured data sharing unit 328 of the client terminal 121 generates the shared captured data for which captured data to be shared and the sharing destination user are set.

After that, in step S640, the captured data sharing unit 328 of the client terminal 121 transmits the shared captured data generated in step S638 described above to the shared captured data reception unit 360 of the virtual space management server 111.

Upon receiving the shared captured data, in step S642, the shared captured data reception unit 360 of the virtual space management server 111 stores the received shared captured data in the shared captured data management unit 362, and returns a response indicating that the shared captured data has been received to the captured data sharing unit 328 of the client terminal 121. After completion of the processing of step S642, the state illustrated in FIG. 4E is obtained.

Next, processing to be performed by the client terminal 131 operated by the sharing destination user will be described.

The processes of steps S644 to S650 are similar to processes of steps S612 to S618, respectively, except for the client terminal to be operated, and thus the descriptions thereof are omitted.

In step S652, the captured data obtaining unit 380 of the client terminal 131 issues a captured data obtaining request to the captured data providing unit 364 of the virtual space management server 111.

At the step of issuing the captured data obtaining request in step S652 described above, it is unknown whether the sharing setting is made on the client terminal 131.

After the captured data providing unit 364 of the virtual space management server 111 receives the captured data obtaining request, the processing proceeds to step S654.

In step S654, the captured data providing unit 364 of the virtual space management server 111 collates the shared captured data to check whether the login user of the client terminal 131 that has issued the captured data obtaining request is included in the list of sharing destination users in the shared captured data management table illustrated in Table 4.

Next, in step S656, the captured data providing unit 364 of the virtual space management server 111 returns all captured data set as captured data to be shared with the sharing destination user based on the collation result in step S654 described above. If the captured data providing unit 364 determines that there is no captured data set as captured data to be shared with the sharing destination user in step S654 descried above, the captured data providing unit 364 returns only a response indicating that there is no captured data to be shared, without returning any captured data in step S656.

After the captured data obtaining unit 380 of the client terminal 131 receives the response from the virtual space management server 111, the processing proceeds to step S658.

If the captured data obtaining unit 380 can obtain at least one piece of captured data in step S656 described above, in step S658, the virtual object generation unit 382 of the client terminal 131 generates a virtual object that can be projected on the virtual space based on the obtained captured data. Further, the virtual object generation unit 382 additionally projects the generated virtual object on the display 206 of the client terminal 131 via the display unit 372.

As described above, since the client terminals 121 and 131 may be used in respective different real spaces, the virtual object generation unit 382 of the client terminal 131 cannot determine the projection position using the spatial anchor feature in some cases. In this case, the virtual object generation unit 382 of the client terminal 131 determines the projection position so that the virtual object can be projected at an appropriate position (e.g., on a table or the like within the virtual space).

After completion of the processing of step S658, the state illustrated in FIG. 4F is obtained.

Like the processing of steps S648 and S650, the processing of steps S652 to S658 is executed asynchronously and repeatedly.

Some of the processing operations performed by the virtual space management server 111, the client terminal 121, and the client terminal 131 described in the present exemplary embodiment can also be implemented on any of the virtual space management server 111, the client terminal 121, and the client terminal 131. For example, as the processing of generating a virtual object based on captured data executed by the virtual object generation unit 382, the virtual space management server 111 may generate a virtual object in advance so that the virtual object can be projected immediately after the virtual object is obtained on the client terminal of the captured data sharing destination. The processing of steps S654 and S656 performed by the virtual space management server 111 can also be implemented by the client terminal 121. For example, a configuration may also be employed in which the client terminals 121 and 131 are working in the same real space and the client terminals 121 and 131 share captured data by direct communication without involving the virtual space management server 111. In this case, captured data sharing processing can be implemented by the configuration in which the client terminal 121 includes the functions of the shared captured data reception unit 360, the shared captured data management unit 362, and the captured data providing unit 364 of the virtual space management server 111. In other words, the processing described in the present exemplary embodiment can also be implemented such that some of the processing operations are shared or performed in cooperation by the virtual space management server 111, the client terminal 121, the client terminal 131.

As described above, the configurations of the client terminals 121, 122, and 131 and the virtual space management server 111 make it possible for a user to seamlessly integrate a physical object in the real space into the virtual space and also share the captured data with another user with a simple operation without the need for putting on or taking off the HMD.

For example, there is a case where in a virtual office, a virtual reality (VR) conference, or the like, a physical object held by the user is integrated into the virtual space as a virtual object and the virtual object is shared so that the virtual object can be handled by another user within the virtual space. In such a case, it may be desirable to generate a virtual object based on a physical object so that the virtual object can be handled in the virtual space, instead of simply projecting an image of a physical object captured by the camera on the virtual space displayed on the HMD worn by the user. To generate a virtual object based on a physical object, it may be desirable to capture images of the physical object from a plurality of angles with the camera and to generate stereoscopic 3D data. However, in the related art, the user needs to put on or take off the HMD during image capturing of the physical object with the camera, and the operation for integrating a virtual object into the virtual space and sharing the virtual object is complicated, which leads to a deterioration in user experience. On the other hand, in the present exemplary embodiment, the above-described configurations enable the user to integrate a physical object in the real space into the virtual space and share the virtual object with another user with a simple operation without the need for a complicated operation such as putting on or taking off the HMD. That is, it is possible to provide a virtual space management system capable of seamlessly integrating a physical object in the real space captured with a camera into the virtual space on the HMD worn by the user and sharing the virtual object with another user with a simple operation.

A second exemplary embodiment will be described. The first exemplary embodiment described above illustrates a method for integrating a stereoscopic physical object (3D data) into a virtual space generated based on images captured from a plurality of angles with a camera and sharing the virtual object with another user present in the same virtual space. There may be a case where a user wants to share not only 3D data, but also a planar physical object (two-dimensional (2D) data), such as an image and text data, with another user. In this case, like in the first exemplary embodiment, a physical object can be integrated into the virtual space as a virtual object. However, if 2D data is used, for example, it may be suitable to use a form that can be handled by a personal computer (PC), a chat application, or the like, instead of using a virtual object.

As an application example of the method described in the first exemplary embodiment, the second exemplary embodiment illustrates a method for integrating a planar physical object in the real space into a virtual space and posting the object to a chat provided by the collaboration application management unit 366 in order to share the object with another user.

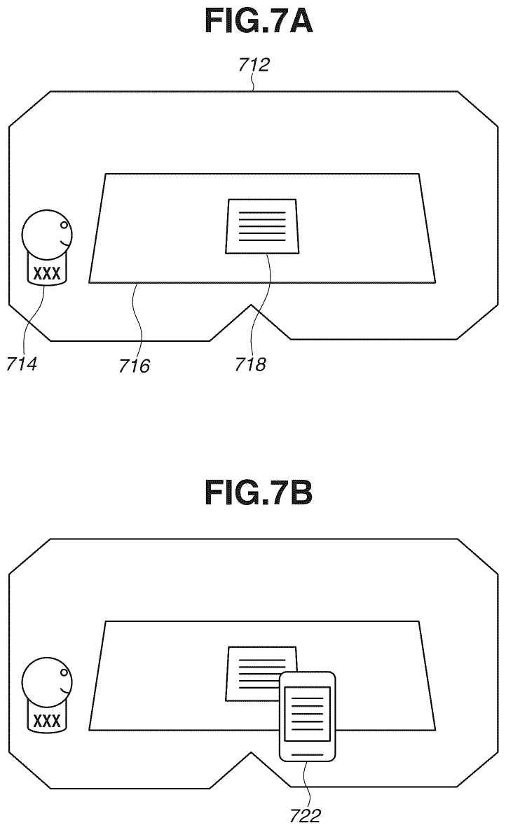

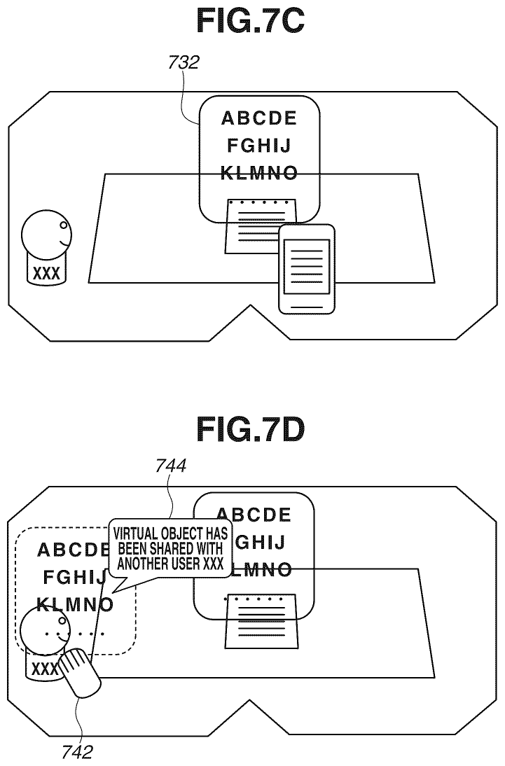

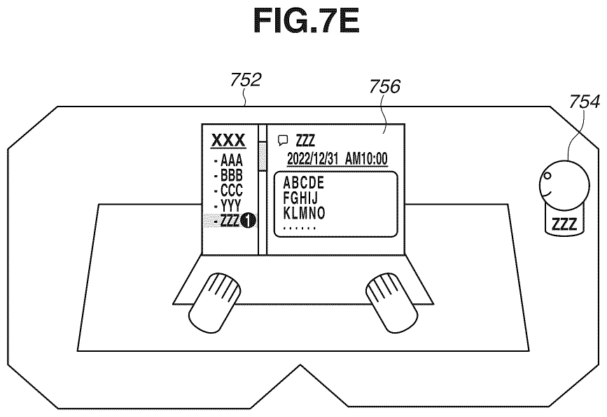

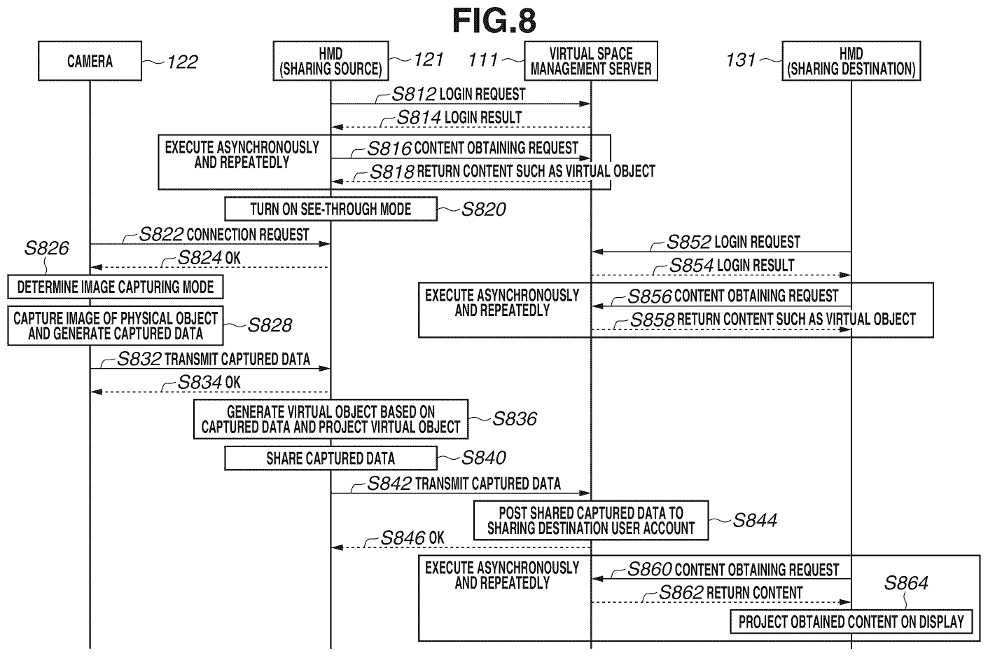

The configuration according to the second exemplary embodiment will be described in detail below with reference to FIGS. 7A to 7E and FIG. 8.

FIGS. 7A to 7D each illustrate an example of a video image of a virtual space projected on the display 206 of the client terminal 121 according to the second exemplary embodiment.

FIG. 7E illustrates an example of a video image within the virtual space displayed on the display 206 of the client terminal 131 according to the second exemplary embodiment.

FIG. 8 is a sequence diagram illustrating an example of an overall processing sequence according to the second exemplary embodiment.

FIG. 7A illustrates a video image of a virtual space projected on the display 206 of the client terminal 121 when the see-through mode is ON.

A display 712 represents a display example on the display 206 of the client terminal 121.

An avatar 714 represents another user present in the same virtual space in which the operation user of the client terminal 121 is present.

An object 716 represents a table present in the real space in which the user operating the client terminal 121 is present.

An object 718 is a physical object to be integrated into the virtual space, and represents a print material on which optical character recognition (OCR) can be performed.

FIG. 7B illustrates an example of a video image of the physical object 718 captured by the user operating the client terminal 121 when the see-through mode is ON, like in FIG. 4C.

An object 722 represents the client terminal 122 connected to the client terminal 121. The operation user of the client terminal 121 is identical to the operation user of the client terminal 122.

Assume that, in the second exemplary embodiment, the image capturing processing on the client terminal 122 is performed by pressing the button 516 or the button 518 illustrated in FIG. 5A. When the image capturing processing is performed by pressing the button 516 or the button 518, the captured data generation unit 338 generates captured data on the physical object as image data or text data. Specifically, when the button 516 is pressed (when the image capturing mode indicates “image”), the captured data generation unit 338 captures an image of the physical object and generates captured data including image data. When the button 518 is pressed (when the image capturing mode indicates “text”), the captured data generation unit 338 generates captured data including text data obtained by character recognition using OCR processing from image data generated by capturing an image of the physical object. In the second exemplary embodiment, the physical object is integrated as 2D data into the virtual space, so that there is no need to capture images of the physical object from a plurality of angles as illustrated in FIG. 5B. The second exemplary embodiment is described assuming that the user presses the button 518 to integrate the physical object as text data into the virtual space. Also, a processing sequence to be performed when the button 516 is pressed can also be implemented according to the processing sequence illustrated in FIG. 8.

FIG. 7C illustrates a display example where, like in FIG. 4D, a virtual object is generated by image capturing processing performed by the client terminal 122 when the see-through mode is ON and the virtual object is projected on the display 206 of the client terminal 121.

A virtual object 732 is obtained by projecting the content of text data on the physical object 718 on the display 206 of the client terminal 121. At this time, the virtual object 732 is still a virtual object.

FIG. 7D illustrates an operation in which, like in FIG. 4E, the client terminal 122 shares the content of text data on the virtual object 732 with another user present in the same virtual space when the see-through mode is ON.

A virtual object 742 represents a hand of the avatar of the user operating the client terminal 121, or a video image of the actual hand of the user. The user operating the client terminal 121 holds the virtual object 732 with the hand, and performs the sharing operation by dropping the virtual object 732 on the avatar (in this case, avatar 714) of the user with which the virtual object is to be shared. A virtual object 744 is a virtual object to be displayed when the sharing setting is made by the operation described above.

Like in the first exemplary embodiment, the second exemplary embodiment described above illustrates an example of the method of the operation for sharing a virtual object with another user. However, the operation method is not limited to this example.

FIG. 7E illustrates a video image of a virtual space projected on the display 206 of the client terminal 131, like in FIG. 4F. In the second exemplary embodiment, there is also no need for the client terminal 131 to turn on the see-through mode because the client terminal 131 does not perform image capturing processing on a physical object.

A display 752 indicates a display example on the display 206 of the client terminal 131.

An avatar 754 represents the user that operates the client terminal 121 as the sharing source user.

An object 756 is a virtual object obtained by projecting a UI for the operation user of the client terminal 131 to perform an operation within the virtual space. The present exemplary embodiment illustrates an example where a virtual object representing a PC to be used in the real space is set. Further, a chat screen is projected on an area corresponding to a display within the virtual object 756. This chat corresponds to a chat function provided by the collaboration application management unit 366 included in the virtual space management server 111. When the operation user of the client terminal 121 performs the sharing operation to share the virtual object 732 with the avatar of the operation user of the client terminal 131, shared text data is projected on the chat projected on a display area of the virtual object 756.

Next, an overall processing sequence will be described with reference to FIG. 8. Processing to be performed by the client terminal 121 illustrated in FIG. 8 is implemented by the CPU 202 of the client terminal 121 reading out programs stored in the ROM 204 or the HDD/SSD 205 and executing the programs. Processing to be performed by the client terminal 122 is implemented by the CPU 202 of the client terminal 122 reading out programs stored in the ROM 204 or the HDD/SSD 205 and executing the programs. Processing to be performed by the virtual space management server 111 is implemented by the CPU 202 of the virtual space management server 111 reading out programs stored in the ROM 204 or the HDD/SSD 205 and executing the programs. Processing to be performed by the client terminal 131 is implemented by the CPU 202 of the client terminal 131 reading out programs stored in the ROM 204 or the HDD/SSD 205 and executing the programs.

The processes of steps S812 to S824 are similar to processes of steps S612 to S624, respectively, and thus the descriptions thereof are omitted. Next, in step S826, when the user presses one of the buttons 514, 516, and 518 as illustrated in FIG. 5A, the image capturing control unit 336 of the client terminal 122 determines the image capturing mode. The user can select “3D”, “text”, or “image” as the image capturing mode. The options for the image capturing mode can be increased depending on a use application. The method for the determination of the image capturing mode is not limited to the method using the UI on which the user to press a button as illustrated in FIG. 5A. For example, the image capturing mode may be determined based on a user's gesture, or the image capturing mode of “text” or “image” may be automatically determined by performing OCR or extraction of edges of an object as an image capturing target by the image capturing control unit 336 of the client terminal 122. In this case, as described above, the user presses the button 518 and the physical object is integrated into the virtual space as text data. Accordingly, the present exemplary embodiment is described assuming that “text” is selected as the image capturing mode.

Next, in step S828, the captured data generation unit 338 of the client terminal 122 captures images of the physical object and generates captured data, like in step S626 illustrated in FIG. 6, and adds an attribute “captured data type” corresponding to the image capturing mode selected in step S826 described above to the generated captured data.

Table 5 illustrates an example of a shared captured data management table to be managed by the shared captured data management unit 362 according to the second exemplary embodiment. The shared captured data management table illustrated in Table 5 is obtained by extending the shared captured data management table illustrated in Table 4 described in the first exemplary embodiment. An attribute corresponding to an item selected as the image capturing mode described above is input to a captured data type row in Table 5. As indicated by the captured data type row in Table 5, data obtained by adding the captured data type to the captured data described in the first exemplary embodiment is treated as new “captured data” in the following processing.

TABLE 5
Shared Captured Data Management Table

| Sharing | Sharing | Sharing | Captured | Captured |
|---|---|---|---|---|
| ID | Source User | Destination User | Data ID | Data Type |
| shareA | userA | userB | capturedDataA | 3D |
| shareB | userA | userC | capturedDataA | 3D |
| shareC | userB | userC | capturedDataB | 3D |
| shareD | userD | userE | capturedDataC | Image |
| shareE | userA | userB | capturedDataD | Text |

The processes of steps S832 to S842 are similar to processes of steps S630 to S640, respectively, and thus the descriptions thereof are omitted.

Upon receiving shared captured data from the client terminal 121, in step S844, the shared captured data reception unit 360 of the virtual space management server 111 refers to the captured data type of the received shared captured data. If the shared captured data reception unit 360 determines that the captured data type to be “text” or “image”, the shared captured data reception unit 360 instructs the collaboration application management unit 366 to post the shared captured data (in this case, “text data”) to an account for the sharing destination user. Further, the collaboration application management unit 366 of the virtual space management server 111 manages the shared captured data so that the operation user of the client terminal 131 as the sharing destination user can obtain the text data (chat message projected on the UI of the virtual object 756).

In step S846, the shared captured data reception unit 360 of the virtual space management server 111 returns a response indicating that the shared captured data has been received to the captured data sharing unit 328 of the client terminal 121. If the captured data sharing unit 328 transmits shared captured data with the captured data type “3D” in step S842, the subsequent processing is similar to the processing prior to step S640 illustrated in FIG. 6 described in the first exemplary embodiment.

Next, processing to be performed by the client terminal 131 will be described. The processes of steps S852 to S858 are similar to processes of steps S644 to S650, respectively, and thus the descriptions thereof are omitted.

In step S860, the collaboration application control unit 384 of the client terminal 131 issues a request for obtaining content, such as a chat message, to the collaboration application management unit 366 of the virtual space management server 111.

After the collaboration application management unit 366 of the virtual space management server 111 receives the content obtaining request, the processing proceeds to step S862.

In step S862, if a chat message is present in the account for the user that has logged in to the client terminal 131, the collaboration application management unit 366 returns the chat message to the collaboration application control unit 384 of the client terminal 131.

After the collaboration application control unit 384 of the client terminal 131 receives the response from the virtual space management server 111, the processing proceeds to step S864.

In step S864, if the collaboration application control unit 384 of the client terminal 131 can obtain a chat message in step S862 described above, the collaboration application control unit 384 of the client terminal 131 projects the obtained chat message on the display 206 via the display unit 372 of the client terminal 131. After completion of the processing of step S864, the state illustrated in FIG. 7E is obtained. In the display example illustrated in FIG. 7E, text data is posted to the chat. In the case of using image data, an attachment file is posted to the chat.

As described above, the captured physical object image can be shared using a more suitable projection method by changing the method of sharing the captured image with the sharing destination user depending on the data type of the physical object corresponding to the virtual object, i.e., by sharing the captured image in the form depending on the data type of the physical object corresponding to the virtual object.

According to the exemplary embodiments described above, it is possible to seamlessly integrate a physical object in the real space into the virtual space and share the integrated physical object with another user with a simple operation without the need for a complicated operation, such as putting on or taking off the HMD.

The configurations and content of various data described above are not limited to the above-described examples, and any other configurations and content may be used depending on the application and purpose.

While exemplary embodiments of the present disclosure have been described above, the present disclosure can be implemented as, for example, a system, an apparatus, a method, a program, or a storage medium. Specifically, the present disclosure can be applied to a system constituted by a plurality of devices, or can be applied to an apparatus constituted by a single device.

All combinations of the configurations according to the exemplary embodiments described above are also included in the present disclosure.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to an aspect of the present disclosure, it is possible to seamlessly integrate a physical object in a real space into a virtual space and share the integrated physical object with another user with a simple operation without the need for a complication operation such as putting on or taking off an HMD.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-111119, filed Jul. 6, 2023, which is hereby incorporated by reference herein in its entirety.

What is claimed is:

1. A head-mounted display device comprising:
one or more memories storing instructions; and
one or more processors capable of executing the instructions causing the head-mounted display device to:
project a virtual space in a field of view of a user wearing the head-mounted display device;
execute control processing to enable a see-through mode to check a real space; and
display a virtual object generated based on captured data on a physical object in the real space within the virtual space projected in the field of view of the user,
wherein the virtual object is shared with another member participating in the virtual space to allow the another member to view the virtual object.

2. The head-mounted display device according to claim 1, wherein the virtual object is shared in a form based on a type of the physical object corresponding to the virtual object.

3. The head-mounted display device according to claim 1, wherein a virtual object generated based on image data on the physical object or text data obtained by performing character recognition on the image data is displayed within the virtual space.

4. The head-mounted display device according to claim 3, wherein the image data or the text data corresponding to the virtual object is posted to an account for a member with which a service having a message posting function is to be shared.

5. The head-mounted display device according to claim 4, wherein the image data or the text data posted to the account for the member with which the service is to be shared is viewed through a screen for the service displayed within a virtual space projected in a field of view of the member.

6. The head-mounted display device according to claim 1, wherein a virtual object generated based on three-dimensional data on the physical object is stereoscopically displayed within the virtual space.

7. The head-mounted display device according to claim 1,
wherein the captured data on the physical object includes data indicating a feature amount of a surrounding real space including the physical object, and
wherein the virtual object generated based on the captured data is displayed at a position within the virtual space based on the feature amount included in the captured data.

8. The head-mounted display device according to claim 1, wherein the instructions further cause the head-mounted display device to issue an instruction to share the virtual object generated based on the captured data with one or more members participating in the virtual space.

9. The head-mounted display device according to claim 1, wherein the instructions further cause the head-mounted display device to receive the captured data from another device.

10. The head-mounted display device according to claim 1, further comprising an image capturing device,
wherein the image capturing device generates the captured data by capturing an image of the physical object.

11. A method for a head-mounted display device, the method comprising:
projecting a virtual space in a field of view of a user wearing the head-mounted display device;
executing control processing to enable a see-through mode to check a real space; and
displaying a virtual object generated based on captured data on a physical object in the real space within the virtual space projected in the field of view of the user,
wherein the virtual object is shared with another member participating in the virtual space to allow the another member to view the virtual object.

12. A non-transitory computer readable storage medium on which is stored a computer program for making a computer execute a method for a head-mounted display device, the method comprising:
projecting a virtual space in a field of view of a user wearing the head-mounted display device;
executing control processing to enable a see-through mode to check a real space; and
displaying a virtual object generated based on captured data on a physical object in the real space within the virtual space projected in the field of view of the user,
wherein the virtual object is shared with another member participating in the virtual space to allow the another member to view the virtual object.
